(19) United States
(12) Patent Application Publication
(10) Pub. No.: US 2020/0292729 A1
(43) Pub. Date: Sep. 17, 2020

(54) Method and apparatus for global warming monitor

(71) Applicant: John Dennis Karna, Tucson, AZ (US)

(72) Inventor: John Dennis Karna, Tucson, AZ (US)

(21) Appl. No.: 16/602,945

(22) Filed: Dec. 31, 2019

Related U.S. Application Data
(60) Provisional application No. 62/919,343, filed on Mar. 11, 2019.

(51) Int. Cl. G01W 1/10

(52) U.S. Cl. CPC G01W 1/10; G01W 2201/00

(57) ABSTRACT

The Global Warming Monitor measures the effect of greenhouse gases on the temperature of a closed biosphere. Global warming of planet earth is then forecasted by comparing the values obtained by this method and apparatus with changes in global greenhouse gas levels.

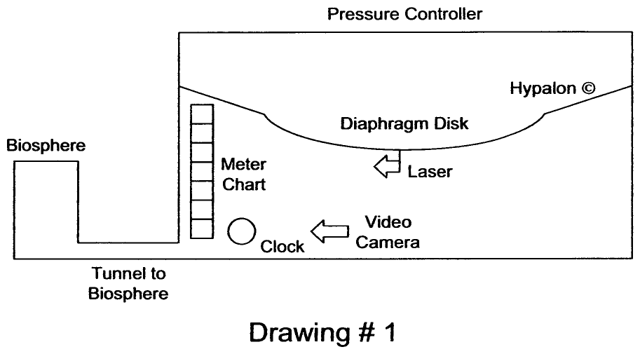

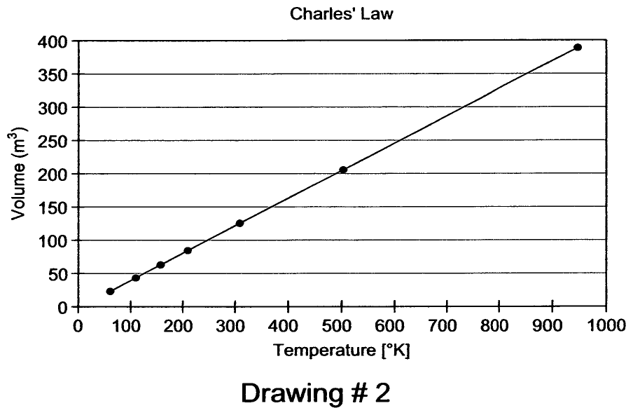

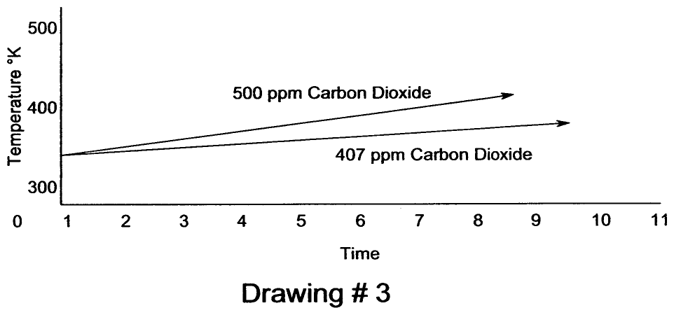

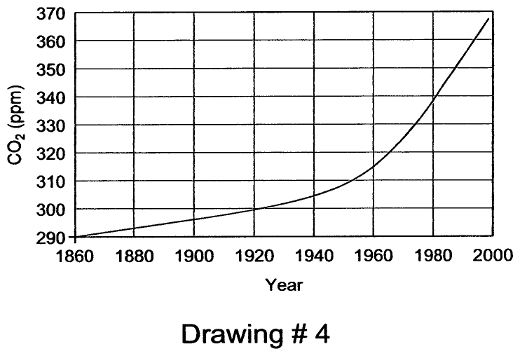

The effect of greenhouse gases on the temperature of a biosphere is determined by correlating the incremental velocity of the bottom plate of the pressure controller with the initial, intermediate, and final temperature in the controller. A laser, timer, meter chart, and video camera are used to provide the incremental velocities.

The Global Warming Monitor provides a quantitative measurement of the effect greenhouse gases have on the velocity of the controller plate, vis-à-vis temperature. Global warming is then forecasted comparing the rates of increase of temperature from greenhouse gases in a biosphere with the change of concentration of atmospheric greenhouse gases.

### BACKGROUND OF THE INVENTION

This invention is directed at quantifying the effects of global atmospheric gases such as water vapor, carbon monoxide, carbon dioxide, methane, nitrous oxide, and ozone individually and collectively on the global warming of our planet. Studies have shown that our planet's ocean temperature is increasing with time due to the effect of the composition of greenhouse gases; therefore, a monitor to determine the effects of greenhouse gases on the temperature of planet earth is needed.

It is known that radiant energy from the sun is 50% absorbed by planet earth. The remaining energy escapes to the atmosphere and a portion of this energy is trapped by greenhouse gases such as water vapor, carbon monoxide, carbon dioxide, methane, nitrous oxide, and ozone. This results in the warming of our oceans. Since the industrial revolution atmospheric carbon dioxide (CO₂) has increased from 280 ppm to 407 ppm.¹ ¹NOAA, Earth System Research Laboratory, Global Monitoring Division, May 10, 2013.

Since the late 1950's the rate of increase has accelerated from about 0.7 ppm per year to 2.1 ppm per year during the last 10 years. As a result ocean pH has reduced from 8.1 to 7.9 by the reaction between carbon dioxide and sea water to form carbonic acid. This has resulted in 50% loss of coral reef mass due to the inability of calcium carbonate to form.² ²University of Arizona Department of Oceanography, private communication 2019

“Data from the US National Oceanic and Atmospheric Administration (NOAA) shows that the average global sea surface temperature—the temperature of the upper few metres of the ocean—has increased by approximately 0.13° C. per decade over the past 100 years.³” Modelling studies published by The Intergovernmental Panel on Climate Change (IPCC) 2013 Report predict that there is likely to be an increase in mean global ocean temperature of 1-4° C. by 2100.”⁴ ³Ocean Warming, International Union for Conservation (IUCN), https://goo.gl/images/4Z2hQo⁴International Panel on Climate Change, https://archive.ipcc.ch/McMurray,

It is not clearly shown in these IPCC data that the increase in temperature for the high temperature increase is an exponential relationship. But it has been shown that with the passage of time there has been a transition from a linear to an exponential relationship between atmospheric carbon dioxide, a greenhouse gas that causes global warming, and time expressed in years. See Drawing 4.⁵ This means that global warming may be a problem more serious than these investigators have estimated. ⁵McMurray, Castellion, and Ballantine, Fundamentals of General, Organic, and Biological Chemistry 5^{th} Ed. page 234, Pearson Prentice Hall 2007. On Dec. 6, 2019 permission to use this textbook as a reference was given by email from Dr. John McMurray, Professor Emeritus at Cornell University. The reference on the abscissa ends with the year 2000. Drawing #3 does not support the claims of this patent application. The drawing merely illustrates that the Global Warming Monitor is useful.

One should not ignore the immediate problem of global warming with the recent empirical events of land disappearing in Isle de Jean Charles,⁶ the melting of glaciers,⁷ the large icebergs being released from Antarctica,⁸ and the shrinking size of birds⁹. The Global Warming Monitor provides an algorithm that quantifies global warming so that they who deny global warming cannot deny the reality anymore. Atmospheric scientists are very concerned that global warming is occurring with more devastating effects forthcoming. ⁶Jenny Jarvic, On a sinking Louisiana island, many aren't ready to leave, Los Angeles Times, Apr. 23, 2019.⁷https://Climate.nasa.gov/climate-resource-s/4/graphic-dramatic-glacier-melt/⁸https://climate.nasa.gov/news/2606/massive-iceberg-breaks-off-from-antactica/⁹www.nbcnews.com/science/environment/birds-are-getting-smaller-scientists-sea-echo-climate-change-n1096726

As those skilled in the art and others will readily recognize a monitor is desperately needed to determine the extent and rate of change of global warming. Politically, global warming is a divisive issue. The Global Warming Monitor will put this controversy to rest. This monitor will undoubtedly result in an increase in innovations to combat the effects of global warming.

Global warming affects the ability of plants to photosynthesize producing our much-needed gaseous oxygen. Columbia University has shown that at about 600 ppm carbon dioxide rain forest plants lose the ability to convert more CO₂ to O₂.¹⁰ This is a serious problem because 20% of the earth's atmospheric oxygen comes from the rain forests. In other words, 1 out of 5 breaths we take come from the rain forest. If carbon dioxide continues its exponential increase, this threshold will be reached sooner than we think. ¹⁰Private communication with Denise Young, Interpretive Specialist of Biosphere 2

Global warming also affects the coral reefs that are adversely affected by warming temperatures resulting in coral bleaching.¹¹ As stated, coral reefs are adversely affected by increasing acidity resulting in a decrease in carbonate anion needed for formation of calcium carbonate. ¹¹Private communication with Denise Young, Interpretive Specialist of Biosphere 2

It will be appreciated that in order to prevent the damaging effects environmental disasters an increased awareness of the extent of global warming is urgently needed. Research, discovery, and innovations will result through use of the Global Warming Monitor.

The Global Warming Monitor is a novel modification of the “Lung” apparatus located at Biosphere 2, registered United States Trademark #1672027 dated Jan. 14, 1992, in Oracle, Ariz. The lung prevents pressure changes due to temperature changes to prevent the blowing out or blowing in of the glass panes surrounding a closed Biosphere 2 system. The operation of the lung is based on the combined gas law, PV=nRT, where P is the pressure, V is the volume, n is the number of moles of gas, R is the gas constant, and T is the temperature. P, n, and R are constants so the operative algorithm of a biosphere lung is Charles' law as shown in Drawing #2.

The lung worked perfectly from 1991 to 1994 to control the pressure of the closed, sealed Biosphere 2. It worked so well that a back-up lung was never employed. The operable lung was never used to monitor the effect of greenhouse gases on temperature within the biosphere.

Therefore, it is the general object of this invention to provide a new method and apparatus for monitoring global warming by modifying a lung in a biosphere in order to collect data relating a change in concentration of greenhouse gases to the change in temperature of a biosphere, and using this data to forecast global warming of planet earth knowing the composition and concentrations of greenhouse gases of the atmosphere of planet earth.

The change of velocity of the bottom plate as a function of temperature is monitored by a time lapse camera and temperature determination system that correlates the rate of plate change with the initial, intermediate, and final temperature ° K. The change in velocity is correlated with the temperature of a concentration of greenhouse gases in a closed biosphere, and the temperature from the statistical analysis is correlated with the biosphere greenhouse gases. The concentration of biosphere greenhouse gases are compared to planet earth's atmospheric concentrations wherein said comparison quantifies the effect global greenhouse gases have on the temperature of planet earth.

The determination of the rate of the rise of the lung disk, vis-à-vis incremental changes, as a function of temperature increase is impossible without the Global Warming Monitor. For example, the Biosphere 2 lung disk and diaphragm weigh 20 tons and comprise a space of 25,000 cubic meters whereas Biosphere 2 minus the lung is 156,000 cubic meters. This is a very large, optimally sized lung which causes the disk to move slowly with temperature increases.

This invention as shown by the claims stated herein is not limited to the Biosphere 2 located near Oracle, Ariz. This invention can be employed by any biosphere containing a pressure regulator controller.

It is a further object of this invention to determine the environmental effects of atmospheric water vapor, carbon monoxide, carbon dioxide, methane, nitrous oxide, and ozone on the temperature of a closed biosphere system.

It is a still further object of this invention to determine the environmental effects of atmospheric water vapor, carbon monoxide, carbon dioxide, methane, nitrous oxide, and ozone on the temperature of planet earth.

### SUMMARY OF THE INVENTION

The method and apparatus of the Global Warming Monitor determines the effect of greenhouse gases on the temperature of a closed, sealed biosphere containing a novel pressure regulator controller. The utility of this patent is the development of rates of change of temperature as a function of time for various biosphere greenhouse gases and comparing those rates with rates of global greenhouse gases to forecast global warming.

### BRIEF DESCRIPTION OF THE DRAWINGS

The foregoing objects and many of the attendant advantages of this invention will become more readily appreciated as the same becomes better understood by reference to the following drawings. Drawing #1 is a depiction of a preferred embodiment of an apparatus formed in accordance with the invention showing the laser affixed to the diaphragm plate and the metric chart. Drawing #2 is Charles' Law, a law that states the volume of an ideal gas at constant pressure is directly proportional to the absolute temperature. Drawing #3 shows the rate of temperature increase as a function of time for various levels of carbon dioxide. Drawing is not to scale, only used for illustration purpose. Drawing #4 shows the concentrations of atmospheric CO₂ have increased dramatically in the last 150 years because of increased use of fossil fuel.

### DETAILED DESCRIPTION OF THE INVENTION

Old Technology of Biosphere 2

An example of a biosphere is located in Oracle, Ariz. Biosphere 2 is an open system, but was closed in the past. From 1991 to 1994 and from 1995 to 1996 a “lung” chamber was used to control pressure inside the closed biosphere. The lung has not been used since 1996 because Biosphere 2 has maintained an open system status. This invention requires the closure of Biosphere 2 or any biosphere of similar design.

A lung maintains a constant pressure in a closed biosphere. Pressure increases in a closed biosphere are caused by increasing temperature. Without a diaphragm “lung” an explosion or implosion of the glass would result from the increase in pressure or decrease in pressure, respectively. In other words, an increase in temperature in Biosphere 2 causes the rise of the diaphragm metal plate and Hypalon© synthetic rubber combination of the lung due to an inflow of hot air from biosphere proper to the lung. The raising of the diaphragm plate increases the volume of air within the lung thus maintaining a constant pressure and preventing any consequential glass explosion of the biosphere.

Conversely, as the temperature decreases in the biosphere the glass would implode. However, the volume of air within the lung decreases by an outflow of air from the lung to the biosphere proper causing the diaphragm plate to lower in order to repeat the cycle the next day.

Thus, the dynamic raising and lowering of the diaphragm plate allows the pressure within a closed biosphere to remain constant thereby the integrity of the closed Biosphere 2 experiments twenty-nine years ago was maintained. Again, a closed biosphere is an operational greenhouse where the temperature increases and decreases would result in harmful pressure increases and decreases, respectively; but for the operation of the lung.

However, the old technology of Biosphere 2 does not provide velocity of the controller bottom plate. Moreover, without a determination of velocity with laser incremental temperature changes are impossible to measure. Further complicating the matter is the plate moves too slowly for simple visual observation. In other words, no useable data is collected by simply measuring the initial and final temperature of a controller without the instant invention.

New Technology of the “Global Warming Monitor”

The Global Warming Monitor and application of its data to planet earth enable a forecast of global warming of planet earth. The Global Warming Monitor satisfies the patentability requirements of new, useful, and nonobvious.

With the use of an affixed laser on a biosphere lung diaphragm metal plate, a meter stick on the interior wall, a timer, and a time lapse video camera the velocity of the rise of the diaphragm plate as a function for various gas compositions and concentrations in a closed biosphere is determined. See Drawing #1. In theory the diaphragm plate rise velocity will change with a change in greenhouse gases such as carbon monoxide, carbon dioxide, methane, and nitrogen oxide. However, since greenhouse gases in a biosphere result in small incremental changes in the temperature, the affixed laser enables a curve fit correlation between changes in plate velocity and the biosphere original, intermediate, and final temperature. In other words, the velocity of the plate gives the absolute and incremental temperature in the lung. The effect of greenhouse gases on temperature changes can be then be determined from the relationship of greenhouse gases and the actual incremental change in biosphere temperature.¹² Again, it is noted that measurement of incremental changes in temperature, vis-à-vis incremental volume, is impossible with the old technology of Biosphere 2. ¹²Charles' Law states that the volume of an ideal gas at constant pressure is directly proportional to the absolute temperature ° K. See Drawing #2.

The temperature of planet earth is then forecasted knowing its varying increasing¹³ atmospheric greenhouse gas composition and comparing those concentrations with the time versus temperature relation of various concentrations of greenhouse gases in the biosphere. See drawing #3. Thus, the Global Warming Monitor provides a forecast of global warming satisfying the patentability requirements of new and useful. ¹³It is noted that parts per million (ppm) for carbon dioxide has increased about 45% during the last two centuries. See Background of Invention.

The experimental control (i.e. baseline) of the operation of the Global Warming Monitor is conducted with ambient air inside a biosphere. The transfer of heat across the glass enclosure is empirically subtracted from the heat generated by greenhouse gases as is the case with experimental runs. Of course, during the execution of claim #2 and #3 there will be an increase in the loss of heat through the glass enclosure due to the higher concentrations of greenhouse gases, but this loss is anticipated to be negligible compared to the temperature increase within the biosphere as greenhouse gases are injected.

The unfortunate consequence of engaging the Global Warming Monitor now is the reality that the baseline control may include ambient carbon dioxide, for example, at its current concentration of 407 ppm. This means that the Global Warming Monitor cannot quantify the effects of an increase of carbon dioxide from preindustrial concentrations of 250 ppm to its current concentration. Perhaps the control as outlined in claim #1 would have an ambient carbon dioxide concentration of 250 ppm, but this would be an unexpected control concentration.

In sum, the forecast of global warming is quantitative given the data of the control. The amount of planet earth greenhouse gases is compared to the rate of change of temperature for elevated biosphere greenhouse gases to enable a forecast of planet earth temperature.

The utility of the Global Warming Monitor is illustrated in drawing #3. The rate of temperature change versus time for several concentrations of carbon dioxide is shown. The drawing shows the effect concentration of carbon dioxide has on the rate of temperature increase. The other greenhouse gases mentioned in this patent will have similar information.

Consider the following hypothetical: the non-dimensional slope of the line permits the superimposition¹⁴ of year from which the Global Warming Monitor method provides a calculation of temperature for the year 2025 for a particular ecosystem having a carbon dioxide ppm of 407. Assume the line has a slope of 1.3, then the temperature for the year 2025 is 375 degree K¹⁵ or an increase of temperature of 32 degree F. from the year 2020 to 2025. ¹⁴Global Warming Monitor hypothetical data from 1 to 11 (daytime hours) where superimposition forecast abscissa 1 is 2020, 3 is 2021, 5 is 2022, 6 is 2023, 7 is 2024, and 8 is 2025.¹⁵Slope=y2−y1/x2−x1 or 1.3=375−343/2025−2000

To repeat these calculations are only made possible by measuring the rise in velocity of the diaphragm plate through the use of a laser and metric chart. Correlation of velocity with the three temperature measurements of original, intermediate, and final enables the calculation of the nondimensional slope.

The weighted average for all major planet ecosystems needs to be calculated to determine the global temperature. Also, the calculation in the preceding paragraph assumes a linear relationship between carbon dioxide concentration and time, but it has been shown that the relationship is now exponential. See drawing #4. Therefore, these estimates of global warming need constant updating for the rising concentrations of carbon dioxide before a weighted average of global warming is determined (i.e. use of 500 ppm line versus 407 ppm line).

Considerations of a Person Skilled in the Art

A person skilled in the art of atmospheric sciences will recognize that before the year of 1950 the average carbon dioxide concentration did not rise above 300 ppm and that the rate increased and decreased on a regular basis. However, after 1950 the amount of carbon dioxide rose sharply to its current level of 407 ppm. This makes it difficult to determine the rate of rise¹⁶ as well as forecasting temperature increases for planet earth. The Global Warming Monitor will quantity the relationship between temperature and greenhouse gases for a biosphere and planet earth. ¹⁶www.climate.nasa.gov/evidence

It will be further recognized by a person skilled in the art of gas law that an unmodified plate itself cannot measure the effect of greenhouse gases on temperature. The problem is that the relatively small increases in lung temperature makes an unmodified lung nonconclusive with respect to greenhouse gases because changes in lung temperature relative to changes in plate position are impossible to measure. However, the Global Warming Monitor provides quantitative measurement of minute changes in temperature.

To explain further, the reason for the difference between an unmodified plate and the Global Warming Monitor is that the volume of a lung is approximately one-sixth (⅙) of the volume of the entire biosphere giving rise to a slow rate of temperature, vis-à-vis slow plate rise, equilibrium between a biosphere proper and a lung. This, of course, is a design parameter of a lung: too small a lung would not have the capacity to regulate pressure and too large of a lung would have been uneconomical. To repeat, minute changes in lung temperature are small and impossible to incrementally measure in an unmodified lung whereas with the use of the Global Warming Monitor the change of plate velocity through the use of a laser, timer, meter marker, and video camera of the diaphragm disk is technologically achievable and novel. This difference makes the Global Warming Monitor new and useful.

A best curve fit of velocity of the plate versus beginning, intermediate, and final temperature as a function of greenhouse gases provides the algorithm necessary to forecast planet earth temperatures knowing the greenhouse gas content of planet earth. The unique algorithm of the Global Warming Monitor is desperately needed by environmental scientists to quantify the warming of planet earth by greenhouse gases.

A person skilled in the art of environmental science will recognize that comparing the data of drawing #3 with atmospheric carbon dioxide will yield a forecast of warming of a particular ecosystem. This is accomplished by using the nondimensional slope of the appropriate line. For example, today's average atmospheric concentration of carbon dioxide is 407 ppm. The original data is gathered during the hours during the day when the diaphragm disk is rising. The temperature data is gathered from the correlation of the diaphragm plate velocity and the original, intermediate, and final temperature.

A previously stated, the nondimensional slope of the line in drawing #3 permits the superimposition¹⁷ of year from which the Global Warming Monitor method provides a calculation of temperature for the year 2025 for a particular ecosystem having a carbon dioxide ppm of 407. Assume the line has a slope of 1.3, then the temperature for the year 2025 is 375 degree K¹⁸ or an increase of temperature of 32 degree F. from the year 2020 to 2025. ¹⁷Global Warming Monitor hypothetical data from 1 to 11 (daytime hours) where superimposition forecast abscissa 1 is 2020, 3 is 2021, 5 is 2022, 6 is 2023, 7 is 2024, and 8 is 2025.¹⁸Slope=y2−y1/x2−x1 or 1.3=375−343/2025−2000

Also as previously stated the weighted average for all major planet ecosystems needs to be calculated to determine the global temperature. Also, the calculation in the preceding paragraph assumes a linear relationship between carbon dioxide concentration and time, but it has been shown that the relationship is now exponential. Therefore, these estimates of global warming need constant updating for the rising concentrations of carbon dioxide before a weighted average of global warming is determined (i.e. use of 500 ppm line versus 407 ppm line).

The embodiments of the invention in which an exclusive property or privilege is claimed are defined as follows:

1. A method and apparatus for monitoring an atmosphere containing greenhouse gases to provide a quantification of the effect of the level of greenhouse gases has on a biosphere atmosphere:
sampling the atmosphere to obtain samples thereof;
determining the ambient and greenhouse gas content of the samples;
determining the initial, intermediate, and final temperature of the atmosphere;
determining the distance and time of the movement of the diaphragm plate of an atmospheric pressure controller through the use of a laser, timer, meter marker and video camera in a closed biosphere to determine velocity of the bottom plate;
determining the integral velocity of the diaphragm plate at various closed biosphere greenhouse gas compositions and concentrations;
correlating the diaphragm plate velocity with the initial, intermediate, and final temperature of a closed biosphere; and
correlating the temperature of a closed biosphere with the closed biosphere greenhouse gas compositions and concentrations.

2. A method and apparatus for monitoring an atmosphere containing greenhouse gases to provide a quantification of the effect of the level of greenhouse gases has on a closed biosphere atmosphere:
sampling of a closed biosphere atmosphere to obtain samples of water vapor, carbon monoxide, carbon dioxide, methane, nitrous oxide, and ozone;
determining the water vapor, carbon monoxide, carbon dioxide, methane, nitrous oxide, and ozone content of the samples;
varying the amount of water vapor, carbon monoxide, carbon dioxide, methane, nitrous oxide, and ozone individually and collectively;
determining the distance and time of the movement of the diaphragm plate of an atmospheric pressure controller through the use of a laser, timer, meter marker and video camera in a closed biosphere to determine velocity of the bottom plate;
determining the integral velocity of the diaphragm plate at various closed biosphere greenhouse gas compositions and concentrations;
correlating the diaphragm plate velocity with the initial, intermediate, and final temperature of a closed biosphere; and
correlating the temperature of a closed biosphere with the closed biosphere greenhouse gas compositions and concentrations; and
determining the rate of rise of temperature in a closed biosphere as a function of time for greenhouse gases individually and collectively.

3. A method and apparatus for determining the effect of global greenhouse gases on the temperature of planet earth:
injecting amounts of water vapor, carbon monoxide, carbon dioxide, methane, nitrous oxide, and ozone into the biosphere;
sampling of a closed biosphere atmosphere to obtain samples of water vapor, carbon monoxide, carbon dioxide, methane, nitrous oxide, and ozone;
determining the water vapor, carbon monoxide, carbon dioxide, methane, nitrous oxide, and ozone content of the samples;
varying the amount of water vapor, carbon monoxide, carbon dioxide, methane, nitrous oxide, and ozone individually and collectively;
determining the initial, intermediate, and final temperature of the closed biosphere atmosphere;
determining the distance and time of the movement of the diaphragm plate of an atmospheric pressure controller through the use of a laser, timer, meter marker and video camera in a closed biosphere to determine velocity of the bottom plate;
determining the integral velocity of the diaphragm plate at various closed biosphere greenhouse gas compositions and concentrations;
correlating the diaphragm plate velocity with the initial, intermediate, and final temperature of a closed biosphere;
correlating the temperature of a closed biosphere with the closed biosphere greenhouse gas compositions and concentrations;
comparing the content of water vapor, carbon monoxide, carbon dioxide, methane, nitrous oxide, and ozone individually and collectively in the earth's atmosphere with the effects of water vapor, carbon monoxide, carbon dioxide, methane, nitrous oxide, and ozone individually and collectively of a closed biosphere;
determining the rate of rise of temperature in a closed biosphere as a function of time for greenhouse gases individually and collectively; and
forecasting the effect of global greenhouse gases of water vapor, carbon monoxide, carbon dioxide, methane, nitrous oxide, and ozone individually and collectively have on the temperature of planet earth by comparing the rate of rise of temperature for biosphere greenhouse gases as a function of time for varying levels of greenhouse gases to that of planet earth greenhouse gases rate of rise.
